(19) United States
(12) Patent Application Publication
(10) Pub. No.: US 2026/0066731 A1
(43) Pub. Date: Mar. 5, 2026

(54) INDIVIDUAL CONTROL OF SUB-CONDUCTORS OF A DYNAMOELECTRIC MACHINE STATOR EQUIPPED WITH CONDUCTOR BARS

(71) Applicant: Innomotics GmbH, 90441 Nürnberg (DE)

(72) Inventor: KONRAD BRANDL, Thalmassing (DE)

(73) Assignee: Innomotics GmbH, 90441 Nürnberg (DE)

(21) Appl. No.: 19/106,527

(22) PCT Filed: Aug. 29, 2023
(86) PCT No.: PCT/EP2023/073619

§ 371 Date: Feb. 25, 2025

(30) Foreign Application Priority Data
Sep. 6, 2022 (EP) 22194157.8

(51) Int. Cl. H02K 3/28; H02K 3/24; H02K 11/33; H02K 15/32

(52) U.S. Cl. CPC H02K 3/28; H02K 3/24; H02K 11/33; H02K 15/32; H02K 2213/06

(57) ABSTRACT

A drive includes a rotary dynamoelectric machine having a stator and a rotor separated by an air gap. The stator includes a magnetically conductive body with a winding system in air-gap-facing grooves thereof. The winding system includes in each groove a conductor bar divided into sub-conductors or sub-conductor bundles, electrically contacted at a first end of the conductor bar with an inverter module such that a plurality of sub-conductors or a sub-conductor bundle of the conductor bar are attached to the inverter module, or each of the sub-conductors of the conductor bar is attached to an inverter module, so that a plurality of inverter modules are provided per groove. The sub-conductors or sub-conductor bundles are combined at a second end of the conductor bar at another end face of the magnetically conductive body with the sub-conductors or sub-conductor bundles of further conductor bars to form a short-circuit ring.

The invention relates to a drive comprising a dynamoelectric machine with inverter modules, a method for manufacturing a dynamoelectric machine stator having inverter modules, and the use of such a drive.

Winding systems of dynamoelectric machine stators are constructed from winding wires or conductor bars which are arranged in grooves of a magnetically conductive body of the stator.

If the winding system does not consist of a distributed three-phase winding based on cables or wires but of a number of conductor bars, a high current strength is nonetheless required due to the comparatively low inductance. This high current strength requires only a relatively low voltage (<100 V) due to the low ohmic resistance of the conductor bars. This low voltage allows inverter modules, by means of which the conductor bars are controlled, to be arranged at the dynamoelectric machine with relatively little separation from each other.

These conductor bars are interconnected via a short-circuit ring at one end face of the magnetically conductive body of the stator, and at the other end face of the magnetically conductive body of the stator are fed by respectively assigned inverter modules, as disclosed e.g. in DE 10 2005 032 965 A1.

These low voltages resulting from the winding design allow a compact construction of the complete drive, i.e. the dynamoelectric machine with the power electronics.

Instead of the intricate labor-intensive distributed stator winding, use is made of an economical and robust bar winding in this case. Each individual stator groove is fitted with a bar according to the operating conditions. Each bar is conventionally connected to a dedicated power electronics unit for its power supply and management, i.e. the inverter module. The number of phases of the machine is therefore identical to the number of grooves in the stator. The magnetic field required to operate the machine is generated by high currents (up to several 1000 A) in the stator bars while using low voltages. The high bar currents are then generated in conventional embodiments by means of a parallel connection of semiconductor structural elements (Si structural elements), which places very high demands on the hardware structure and the ignition pulse control of the structural elements of the inverter modules.

Considerable demands are placed on the management software in respect of the simultaneous generation and transfer of the ignition pulses to the power converter.

If switching is delayed in only a few structural elements when using such high currents, this results in thermal destruction of the board structure in the respective inverter module.

Critical in respect of hardware structure are the uniform cooling of the structural elements, the constant current flow and the low-resistance connection design for the (high) current transfer from the board to the stator bar.

Taking this as a starting point, the object of the present invention is to provide a drive comprising a dynamoelectric machine whose stator has conductor bars and a short-circuit ring, and which avoids the disadvantages cited above.

This object is achieved by a drive comprising a rotary dynamoelectric machine with a stator and a rotor, wherein the stator has a winding system in a magnetically conductive body, in particular a laminated core, wherein stator and rotor are separated from each other by an air gap,
wherein the winding system is arranged in grooves of the magnetically conductive body which face the air gap,
wherein the winding system has one conductor bar per groove, which conductor bar is subdivided into sub-conductors or sub-conductor bundles and the sub-conductors or sub-conductor bundles thereof are electrically contacted at a first end of the conductor bar with at least one inverter module and the sub-conductors or sub-conductor bundles thereof are combined at the other end, Le. the second end of the conductor bar at the other end face of the magnetically conductive body of the stator, with the other sub-conductors or sub-conductor bundles of the further conductor bars, arranged in their respective grooves, to form a short-circuit ring.

The stated object is also achieved by a method for manufacturing a stator of a rotary dynamoelectric machine, which stator has a winding system in a magnetically conductive body, in particular a laminated core, said method comprising steps as follows:
manufacturing the magnetically conductive hollow cylindrical body, in particular the laminated core of the stator, with grooves which face the inner circumferential surface of the hollow cylindrical body,
contacting interface elements in each case at a first axial end of a conductor bar of a groove, said conductor bar being constructed from sub-conductors which individually and/or as a sub-conductor bundle are equipped with the interface elements and which run in parallel or transposed at least within the groove,
axially inserting the sub-conductors or sub-conductor bundles, these being equipped with the interface elements, of the respective conductor bars into the respective grooves of the magnetically conductive body or laminated core,
contacting at least one short-circuit ring at the second ends of the conductor bars and positioning and contacting the inverter modules at the sub-conductors or sub-conductor bundles, these being equipped with the interface elements, of the conductor bars.

The stated object is also achieved by a drive for use in an industrial environment, particularly for condensers, compressors or pumps whose dynamoelectric machine has a stator according to the invention.

The intricate labor-intensive distributed winding system in a stator, of a dynamoelectric machine of a drive according to the invention, inventively takes the form of an economical and robust winding system made of conductor bars. Each individual groove of the stator is equipped with a conductor bar that is constructed from sub-conductors. Each sub-conductor or sub-conductor bundle of a conductor bar is connected to a dedicated power electronics unit for its power supply and management, i.e. a dedicated inverter module. The magnetic field that is required to operate the dynamoelectric machine is generated by comparatively high currents in the conductor bars while using low voltages (e.g. <100 V). The current of a conductor bar is divided over the sub-conductors or sub-conductor bundle of this conductor bar accordingly and can be managed in a predeterminable manner.

Sub-conductor in this case is understood to signify the division of a bar-shaped conductor into a plurality of in particular parallel sub-conductors.

The sub-conductors are either bare or insulated from each other.

The sub-conductors can be embodied with different cross-sections, e.g. rectangular or roundish.

A high packing density of the sub-conductors in the groove is preferred in every case. Skin effects and proximity effects can be reduced by twisting the sub-conductors in the groove.

The inventive approach of the drive therefore consists in no longer generating the high bar current by connecting many power converters or inverter modules in parallel, and instead assigning a sub-conductor or a sub-conductor bundle (i.e. two, three, four or more individual parallel-connected sub-conductors) of the conductor bar to each individual power converter element or inverter module.

An inverter module in this case is understood to be a power semiconductor arrangement which is attached on the input side to a D.C voltage source and on the A.C side to a sub-conductor or sub-conductor bundle of a conductor bar, and management of this inverter module (or combined management of the inverter modules) controls the respective power semiconductors accordingly.

The parallel connection of the total current per groove is therefore achieved by the cross-sectional division of the individual conductor bar, and the desired high bar current per groove of the stator is generated by the total of the sub-conductor currents in this groove.

The shift of the parallel connection of the currents from the semiconductor level of an inverter module to the respective individual level of a conductor bar results in a number of advantages:
A constant current flow on the boards of the inverter module to the central interface points is no longer necessary for the current transfer to the conductor bar. In other words: the current is now inventively transferred directly from the inverter module to the bar sub-conductor or bar sub-conductor bundle.
As a consequence, it is not necessary to transfer e.g. 600 A (or even higher currents) with low resistance from the board of the inverter module to the conductor bar by means of special particularly low-resistance connection techniques such as butt welding, but merely e.g. 10×60 A, thereby greatly simplifying the contacting from the inverter module to the sub-conductor or sub-conductor bundle via the respective interface elements thereof, since these can be embodied e.g. as plug-type connections,

By virtue of it consequently being possible to use plug-type connectors as interface elements, replacement of the hardware, e.g. the inverter module during servicing, can be realized more easily.

According to the invention, considerably greater redundancy of the drive is achieved, since it is no longer possible for a whole conductor bar and therefore the relevant inverter module to fail, but at most parts thereof or sub-conductors or sub-conductor bundles or their assigned inverter modules.

A delayed transfer of ignition pulses does not therefore cause the current-carrying capacity of other power semiconductors of the inverter module to be exceeded and is therefore less critical. There might occur, within the conductor bar of a groove, only a very brief current asymmetry and associated field asymmetry relative to conductor bars in adjacent grooves having the same current control. This does not however restrict the correct operation of the drive.

As a result of the shift of the parallel connection of the currents from the semiconductor level of an inverter module to the respectively individual conductor bar level, there are fewer time-critical demands on the management software for generating the ignition pulses of the power semiconductors of an inverter module.

According to the invention, the cooling of the power structural elements of an inverter module is also simplified, since each inverter module can be considered individually and is no longer connected via a shared current flow.

Due to operating frequencies of 50 Hz or more, in order to reduce eddy-current losses, the conductor bar is generally no longer of solid design, but is inventively constructed from sub-conductors which are bare or insulated from each other and can be of solid or hollow design.

Furthermore, viewed over the axial course of the groove, the sub-conductors of a conductor bar can run along any geometric position in the groove.

In particular, the sub-conductors of a conductor bar are transposed. In the case of transposition, the position of each sub-conductor viewed over the axial length of the groove is guided in such a way that current displacement can be avoided. Viewed over the axial course, each section of the sub-conductor of the transposed conductor now experiences on average the same vertical position in the groove over the groove length, and therefore the current density in all twisted parallel sub-conductors is approximately constant and current displacement is avoided. An increase in resistance which is caused by current displacement and is inevitably associated with increased ohmic losses can therefore be significantly reduced.

According to the invention, also by virtue of the decoupling of the sub-conductors of a conductor bar, conductor bars or sub-conductors thereof can therefore also be used without transposition.

According to the invention, instead of the whole cross section, these individual sub-conductors or sub-conductor bundles of a conductor bar are now combined (according to the current-carrying capacity of the power converter on the board) and connected to the semiconductor modules.

In the original embodiment, if e.g. 40 sub-conductors of a bar were combined and 600 A was applied to the conductor bar by means of 10 parallel power converter elements at 60 A each, four sub-conductors are now attached to each of the ten 60-A power converters. This again results in a total of 600 A for the conductor bar in the groove.

The power converter or inverter modules and the software for operating the hardware components are no longer considered separately from each other. Machine and power converter are connected directly together and seen as an integral function unit.

According to the invention, the high bar current is no longer generated by a parallel connection of many structural elements, and each power converter structural element is instead assigned a sub-conductor or sub-conductor bundle of the bar. The parallel connection is therefore effected by means of the cross-sectional division of a conductor bar per groove of the stator, and the high bar current in a groove is now generated by the total of the sub-conductor currents in this groove, without being exposed to an increased failure probability of the inverter module.

The invention and further advantageous embodiments of the invention are explained in greater detail with reference to schematic illustrations of exemplary embodiments, in which:

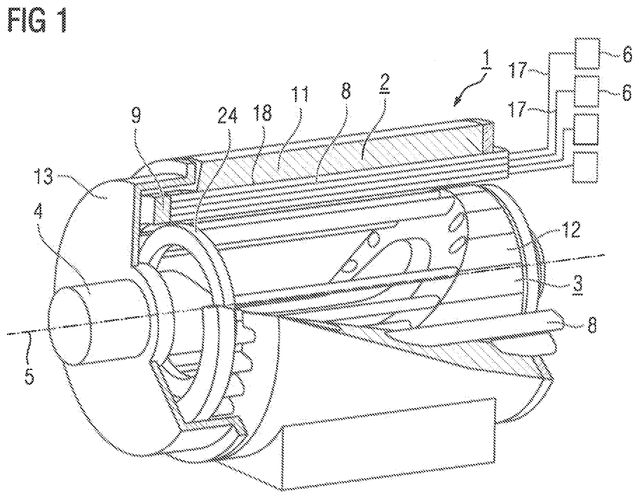

FIG. 1 shows a perspective sectional view of a drive,

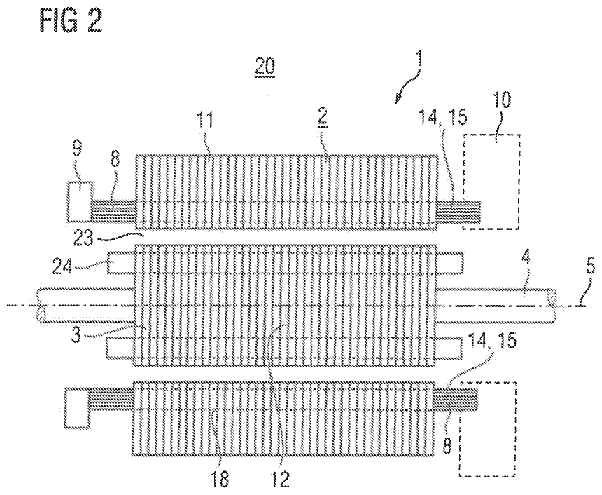

FIG. 2 shows a longitudinal section of a drive,

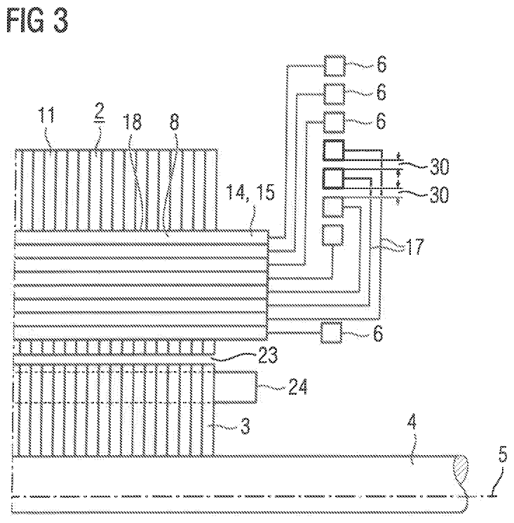

FIG. 3 shows a detail view of a conductor bar at an end face of the stator,

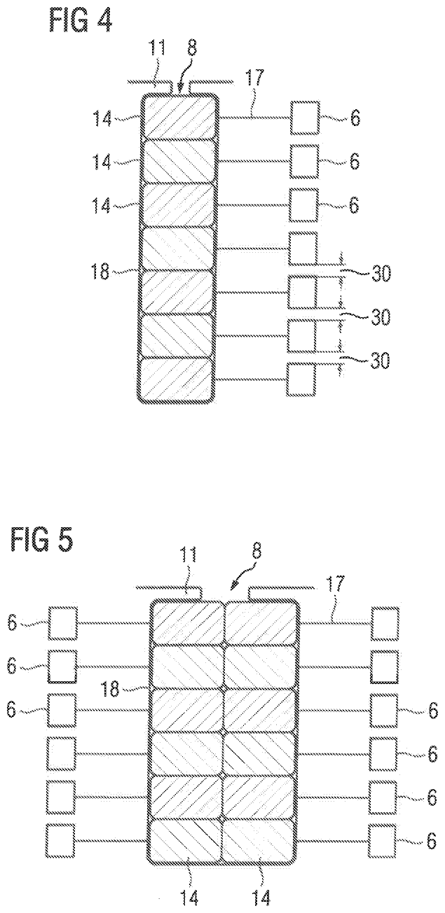

FIGS. 4 to 9 show a wide variety of illustrations of different sub-conductors of a conductor bar,

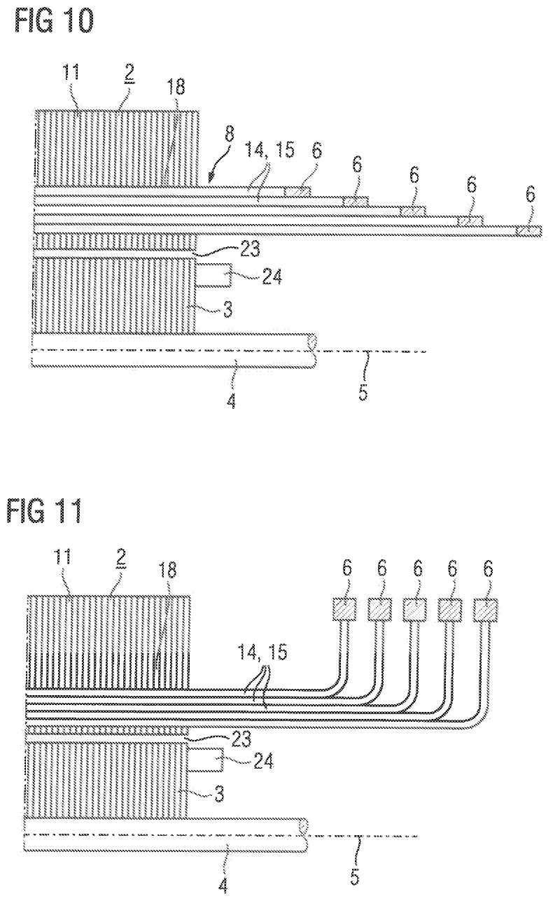

FIGS. 10, 11 show a longitudinal section of a schematic arrangement of inverter modules at sub-conductors of a conductor bar,

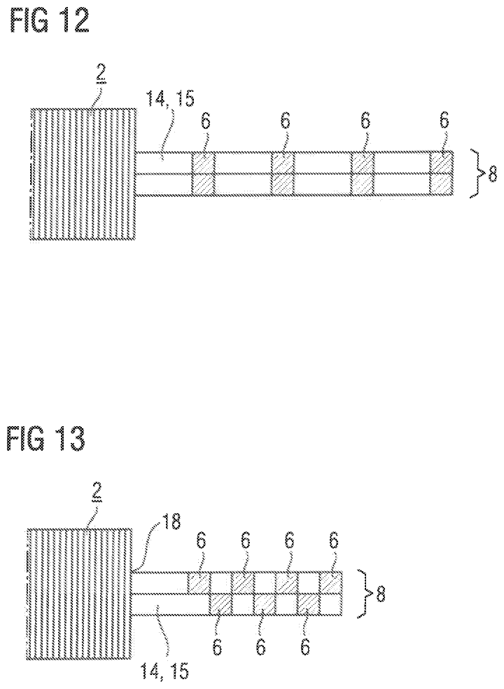

FIGS. 12, 13 show a plan view of a schematic arrangement of inverter modules at sub-conductors of a conductor bar.

It should be noted that terms such as “axial”, “radial”, “tangential” etc. relate to the axis 5 marked in the respective figure or in the example that is described in each case. In other words, the directions axial, radial, tangential always relate to an axis 5 of the rotor 3 and therefore to the corresponding axis of symmetry of the stator 2. In this case, “axial” describes a direction parallel to the axis 5, “radial” describes a direction orthogonal to the axis 5, to or away from it, and “tangential” is a direction which, at a constant radial distance from the axis 5 and with a constant axial position, is oriented circularly around the axis 5. The expression “in a circumferential direction”is equivalent to “tangential”.

In relation to an area, e.g. a cross-sectional area, the terms “axial”, “radial”, “tangential” etc. describe the orientation of the normal vector of that area, i.e. the vector which is perpendicular to the area concerned.

The expression “coaxial structural parts”, e.g. coaxial components such as rotor 3 and stator 2, is understood here to signify structural parts which have the same normal vectors, and for which the planes defined by the coaxial structural parts are therefore parallel to each other. Furthermore, the expression is intended to signify that the midpoints of coaxial structural parts lie on the same axis of rotation or symmetry. These midpoints can nonetheless lie at different axial positions on this axis if applicable, and the cited planes therefore have a separation>0 from each other. The expression does not necessarily require coaxial structural parts to have the same radius.

The term “complementary” in the context of two components which are “complementary” to each other means that their outer shapes are embodied in such a way that that the one component can preferably be arranged completely in the component that is complementary to it, such that the inner surface of the one component and the outer surface of the other component abut in a manner which is ideally continuous or completely flush. Consequently, in the case of two complementary objects, the outer shape of the one object is determined by the outer shape of the other object. The term “complementary” can be replaced by the term “inverse”.

For the sake of clarity in the figures, in some cases where multiple instances of structural parts are present, not all illustrated structural parts are designated by reference signs.

The embodiments described can be combined in any chosen manner. Likewise, individual features of the respective embodiments can be combined without thereby departing from the essence of the invention.

FIG. 1 shows a perspective sectional view of a drive 20 comprising a dynamoelectric machine 1 and inverter modules 6 arranged immediately at the end face thereof. The dynamoelectric machine 1 has a laminated core 11 of a stator 2, in which a winding system 7 is arranged in grooves that face an air gap 23. Said winding system 7 of the stator 2 is in this case constructed from conductor bars 8 which are composed of sub-conductors 14, 15 and which, via interface elements 17 at one end face of the stator 2, are contacted with inverter modules 6 of a conductor bar 8 which are assigned to the sub-conductors 14, 15 or sub-conductor bundles in each case. At the other end face of the stator 2, these conductor bars 8 composed of sub-conductors 14, 15 or sub-conductor bundles are electrically combined to form a short-circuit ring 9 of the stator 2.

Also present at this other end face is a cover 13, which can additionally be embodied as a bearing bracket if applicable.

Separated from the stator 2 by the air gap 23 and coaxially arranged is a rotor 3 which in this case has a cage winding that is likewise arranged in a laminated core 12. The rotor 3 is connected in a non-rotatable manner to a shaft 4 and in this way rotates about the axis 5 during operation of the dynamoelectric machine 1.

FIG. 2 shows the drive 20 in a schematic longitudinal section, the structural space 10 of the inverter modules 6 of the sub-conductors 14, 15 or sub-conductor bundles of the respective conductor bars 8 being arranged at the end face of the dynamoelectric machine 1. This inventive construction results in an extremely compact construction of the complete drive 20, i.e. the dynamoelectric machine 1 with its inverter modules 6.

The inverter modules 6 are electrically attached to a D.C. voltage network or to an intermediate circuit, this being assigned to the drive 20 as part of a converter that is allocated to the drive 20.

FIG. 3 shows a detailed illustration of an end face of the dynamoelectric machine 1, in which the conductor bar 8 is divided into sub-conductors 14, 15 and each sub-conductor 14, 15 has a dedicated inverter module 6. It is obviously also possible for two, three, four or more sub-conductors 14, 15 to be combined into a sub-conductor bundle and controlled or “supplied”by an inverter module.

In this case, the failure probability of the semiconductor elements due to inaccuracies in the ignition pulse control is avoided. This is achieved primarily because the parallel connection of the sub-conductors 14, 15 or sub-conductor bundles is moved into the conductor bar 8. As a result of the lower voltages (<100 V), smaller separations 30 between the inverter modules 6 are required accordingly. By means of these separations 30, it is possible inter alia for the inverter modules 6 to be cooled by a cool airflow during operation of the drive 20.

FIG. 4 shows a conductor bar 8 in which the sub-conductors 14, 15 are arranged radially one above the other in the groove 18 and each sub-conductor 14 is electrically connected to its inverter module 6 via an interface element 17.

FIG. 5 shows a further conductor bar 8 in which the sub-conductors 14 are arranged in pairs radially one above the other in the groove 18. In this case, each sub-conductor 14 is again electrically contacted with its assigned inverter module 6 via an interface element 17, e.g. via plug-type, screw-type, soldered or welded connections.

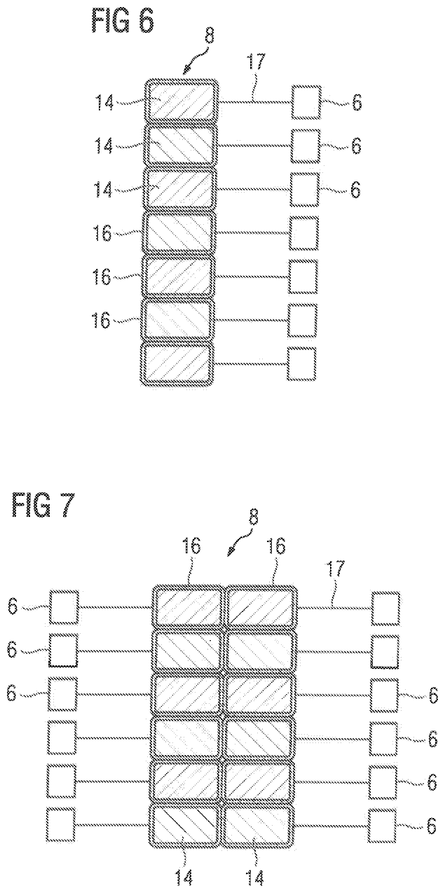

FIG. 6 shows a further possible arrangement of the sub-conductors, which differs from the sub-conductor arrangement according to FIG. 4 only in that the sub-conductors 14 are equipped with a special insulation layer 16.

The sub-conductors 14 according to FIG. 7 are arranged in the same way as the sub-conductors 14 according to FIG. 5 and are equipped with an insulation layer 16.

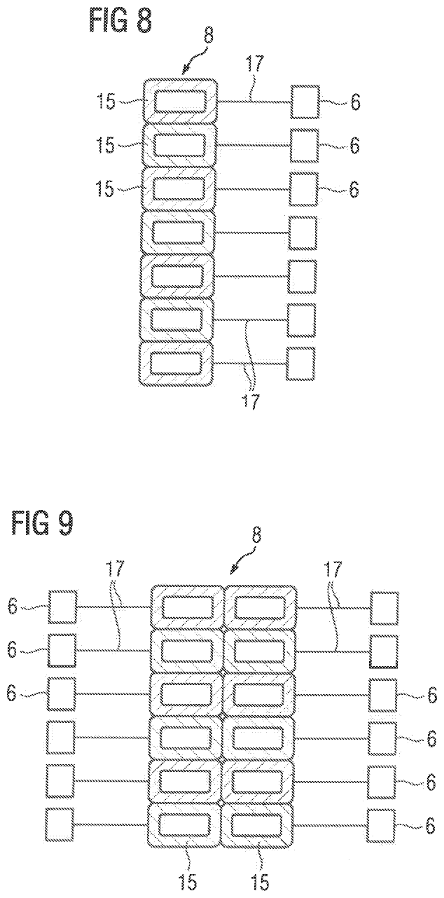

FIG. 8 shows a conductor bar 8 whose radially arranged sub-conductors 15 are of hollow design and are likewise contacted with their respective inverter module 6 via interface elements 7.

FIG. 9 shows a conductor bar 8 whose sub-conductors 15 are arranged in radially adjacent pairs and are likewise of hollow design.

Hollow sub-conductors 15 have the advantage that a cooling liquid can be guided through these sub-conductors 15 if applicable.

All sub-conductors, whether embodied as solid sub-conductors 14 or as hollow sub-conductors 15, can have an insulation layer 16 (plastic or lacquer coating) or be bare. Even in the case of bare sub-conductors 14, 15, an oxide film is nonetheless present which should be sufficient for the insulation within the groove 18 due to the comparatively low voltage potentials between the sub-conductors 14, 15 during operation of the drive 20.

FIG. 10 shows a longitudinal section of a schematic arrangement of inverter modules 6 at sub-conductors 14, 15 of a conductor bar 8. In this case, the sub-conductors 14, 15 have axially differing lengths over an axial course of the conductor bar 8, i.e. parallel to the axis 5, in order inter alia to create a separation 30 of the inverter modules 6.

FIG. 11 shows a longitudinal section of a further schematic arrangement of inverter modules 6 at sub-conductors 14, 15 of a conductor bar 8. In this case, the sub-conductors 14, 15 have axially differing lengths, the ends of the sub-conductors 14, 15 preferably being bent radially outwards in order to position and contact the inverter modules 6 there. It is thereby possible inter alia to create a separation 30 of the inverter modules 6 which improves the cooling of the inverter modules 6 and also simplifies the assembly.

FIG. 12 shows a plan view of a schematic arrangement of inverter modules 6 at sub-conductors 14, 15 of a conductor bar 8. In this case, the view is oriented radially towards the axis 5. The conductor bar 8 in this case is formed e.g. from sub-conductors 14, 15 as per FIGS. 5, 7 and 9, in that the radial height in a groove 18 is occupied by two adjacently arranged sub-conductors 14, 15. In this case, the sub-conductors 14, 15 are arranged adjacently as viewed in a circumferential direction, e.g. as per FIG. 10. In other words: each radial layer of sub-conductors 14, 15 in a groove 18 has an axial length which differs from that of another radial layer, the inverter modules 6 then being situated at the ends of these respective sub-conductors 14, 15. The inverter modules 6 of the sub-conductors 14, 15 in radially different layers of sub-conductors 14, 15 are so arranged as to be axially and radially offset.

FIG. 13 shows a construction similar to the construction in FIG. 12, but in this case the inverter modules 6 of sub-conductors 14, 15 are additionally so arranged as to be also offset in a radial layer.

The arrangements shown here are exemplary and can also relate to more than two sub-conductors per radial layer in a groove 18. Likewise, inverter modules 6 for individual sub-conductors 14, 15 can also be arranged for sub-conductor bundles, Le, sub-conductors 14, 15 which are electrically connected in parallel according to the above embodiments.

In further embodiments, the above cited sub-conductors 14, 15 and/or sub-conductor bundles of the conductor 8 can be guided over the axial length of the stator 2 or the laminated core 11 of the stator 2 either in parallel or transposed. In the case of transposition, the position of each sub-conductor 14, 15 and/or sub-conductor bundle viewed over the axial length is guided in such a way that current displacement can be avoided. Viewed over the axial course of a groove 18, each section of the sub-conductor 14, 15 and/or sub-conductor bundle of the transposed conductor bar 8 now experiences on average the same vertical position in the groove 18 over the axial groove length, and therefore the current density in all twisted parallel sub-conductors 14, 15 and/or sub-conductor bundles is approximately constant and current displacement is avoided. An increase in resistance which is caused by current displacement and is inevitably associated with increased ohmic losses can therefore be significantly reduced.

Such a drive 20 is used in the context of vehicle drives, e.g. ship drives, traction drives in rail transport, heavy goods vehicles and automobiles, and in the industrial environment, in particular for condensers, compressors or pumps, due to its compactness and easy selection of a wide speed range of the drive 20.

1.-11. (canceled)

12. A drive, comprising:
a rotary dynamoelectric machine comprising a stator and a rotor which is separated from the stator by an air gap, said stator including a magnetically conductive body formed with groove which face the air gap, and a winding system which is received in the magnetically conductive body and arranged in the grooves of the magnetically conductive body, said winding system comprising in each of the grooves a conductor bar which is divided into sub-conductors or sub-conductor bundles, with the sub-conductors or sub-conductor bundles being electrically contacted at a first end of the conductor bar with an inverter module such that a plurality of sub-conductors or a sub-conductor bundle of the conductor bar are attached to the inverter module, or each of the sub-conductors of the conductor bar is attached to an inverter module, so that a plurality of inverter modules are provided per groove,
wherein the sub-conductors or the sub-conductor bundles are combined at a second end of the conductor bar at another end face of the magnetically conductive body of the stator with the sub-conductors or the sub-conductor bundles of further ones of the conductor bars, arranged in their grooves, to form a short-circuit ring.

13. The drive of claim 12, wherein the magnetically conductive body is a laminated core.

14. The drive of claim 12, wherein the sub-conductors or the sub-conductor bundles run in parallel at least within the magnetically conductive body.

15. The drive of claim 12, wherein the sub-conductors or the sub-conductor bundles change their position in the groove over an axial course of the groove, at least within the magnetically conductive body,

16. The drive of claim 15, wherein the sub-conductors or the sub-conductor bundles are arranged so as to be transposed.

17. The drive of claim 12, wherein the sub-conductors are embodied as solid or as hollow conductors.

18. The drive of claim 12, wherein the sub-conductors or the sub-conductor bundles are at least partially provided with an insulation layer, when viewed in a circumferential direction.

19. The drive of claim 12, further comprising cooling elements provided between two or more axially and/or radially arranged inverter modules and arranged at least partially in heat-conductive contact with an adjacent one of the inverter modules.

20. The drive of claim 12, for use in an industrial environment, condenser, compressor or pump.

21. A method for manufacturing a stator of a rotary dynamoelectric machine, the method comprising:
manufacturing a magnetically conductive hollow cylindrical body with grooves which face an inner circumferential surface of the hollow cylindrical body;
contacting interface elements at a first axial end of each of conductor bars, with each of the conductor bars being constructed from sub-conductors which individually and/or as a sub-conductor bundle are equipped with the interface elements and running in parallel or transposed at least within the grooves, respectively;
axially inserting the sub-conductors or the sub-conductor bundle with the interface elements of the conductor bars into respective ones of the grooves of the magnetically conductive body; and
contacting a short-circuit ring at a second end of the conductor bars and positioning and contacting inverter modules to the interface elements at the sub-conductors or the sub-conductor bundles of the conductor bars.

22. The method of claim 21, wherein the magnetically conductive hollow cylindrical body embodies a laminated core.

23. The method of claim 21, wherein existing insulation material on the conductor bar is removed as the short-circuit ring is contacted, at least at points of contact.

24. The method of claim 23, wherein the existing insulation material on the sub-conductors or the sub-conductor bundles and/or the interface elements is removed as the short-circuit ring is contacted, at least at points of contact.

25. The method of claim 23, wherein the existing insulation material on the conductor bar is burnt off.
